(19) United States
(12) Patent Application Publication
(10) Pub. No.: US 2009/0213105 A1
(43) Pub. Date: Aug. 27, 2009

(54) DRIVING METHOD OF PLASMA DISPLAY PANEL

(76) Inventors: Jun-Ho Lee, Suwon-si (KR); Woo-Joon Chung, Suwon-si (KR); Tae-Seong Kim, Suwon-si (KR); Seong-Joon Jeong, Suwon-si (KR)

Correspondence Address: CHRISTIE, PARKER & HALE, LLP, PO BOX 7068, PASADENA, CA, 91109-7068, US

(21) Appl. No.: 12/391,978

(22) Filed: Feb. 24, 2009

(30) Foreign Application Priority Data
Feb. 25, 2008 (KR) 10-2008-0016791

(51) Int. Cl. G09G 5/00; G09G 3/28

(52) U.S. Cl. 345/211; 345/60; 345/214

(57) ABSTRACT

A driving method for a plasma display panel capable of stabilizing a sustain discharge. The driving method for a plasma display panel according to exemplary embodiments of the present invention includes applying a signal gradually rising to a first voltage to scan electrodes during a first period of a sustain period, and applying a second voltage to sustain electrodes during the first period.

### CROSS-REFERENCE TO RELATED APPLICATION

This application claims priority to and the benefit of Korean Patent Application No. 10-2008-0016791, filed on Feb. 25, 2008, in the Korean Intellectual Property Office, the entire content of which is incorporated herein by reference.

### BACKGROUND

1. Field of the Invention

The present invention relates to a driving method of a plasma display panel.

2. Description of Related Art

A plasma display panel (hereinafter, referred to as a “PDP”) displays a predetermined image by allowing a phosphor to emit light using ultraviolet rays of approximately 147 nm, which are generated by a discharge of inert mixed gases. Such a PDP may facilitate the manufacture of a thin and large-sized display device and provide an image of highly improved quality with the recent development of manufacturing technologies.

The PDP is driven to realize gray levels of an image in various subfields into which one frame is divided, the subfields having different light emitting numbers. Each of the subfields includes a reset period for resetting the entire panel, an address period for selecting discharge cells to be turned on, and a sustain period for realizing gray levels according to the number of discharges.

A reset discharge is generated in discharge cells during the reset period by supplying a ramp pulse to scan electrodes. Wall charges required for address discharge are distributed essentially uniformly in the discharge cells through the above-mentioned reset discharge.

A scan pulse is sequentially supplied to scan electrodes, and a data pulse is supplied to address electrodes at the same time during the address period. At this time, an address discharge is generated by the addition of the difference in voltages of the data pulse and the scan pulse, and the wall voltage of the wall charges in the discharge cells formed during the reset period. Wall charges, of which the amount may be predetermined, are generated in the discharge cells through the above-mentioned address discharge.

Subsequently, a sustain pulse is alternately supplied to scan electrodes and sustain electrodes during the sustain period. Then, a sustain discharge, in the form of surface discharge, is generated by the addition of the voltage of the sustain pulse and the wall voltage in the discharge cell selected by the address discharge whenever the sustain pulse is supplied to the scan electrodes and the sustain electrodes.

Here, a sustain pulse firstly supplied to the scan electrodes is set to a broader width than a subsequent sustain pulse during the sustain period. More particularly, the sustain discharge firstly caused during the sustain period may be unstable due to the absence of priming particles. Therefore, the first sustain discharge occurs stably in the conventional PDP by setting the first sustain pulse to a relatively broader width.

Meanwhile, the sustain discharge should be caused in the form of surface discharge between the scan electrodes and the sustain electrodes. In fact, the sustain discharge should occur in the form of the surface discharge to display an image with desired luminance. However, the conventional PDP has a problem that it may not display an image with desired luminance since a discharge between the scan electrode and the address electrodes is also caused during the sustain period.

### SUMMARY

Accordingly, various exemplary embodiments of the present invention provide a driving method of a plasma display panel capable of displaying an image with desired luminance by stabilizing a sustain discharge.

One exemplary embodiment of the present invention includes a driving method of a plasma display panel (PDP) including scan electrodes, sustain electrodes, and address electrodes, the scan electrodes and the sustain electrodes crossing the address electrodes at discharge cells. The PDP is configured to display an image frame having a plurality of subfields, each subfield including a reset period, an address period, and a sustain period. According to this method, a signal gradually rising to a first voltage is applied to the scan electrodes during a first period of the sustain period. A pulse having a second voltage is applied to the sustain electrodes during the first period.

The driving method for a plasma display panel according to an exemplary embodiment of the present invention may further include maintaining the first voltage on the scan electrodes during a second period right after the first period. A third voltage, lower than the second voltage, may be applied to the sustain electrodes during the second period. Alternatively, the second voltage may be maintained on the sustain electrodes during an initial portion of the second period, and a third voltage, lower than the second voltage, may be applied to the sustain electrodes during a second portion of the second period following the initial portion of the second period. A first sustain pulse may be supplied to the scan electrodes during a second period right after the first period. The first voltage and the second voltage may be approximately equal to a sustain voltage. The third voltage may be set to a voltage of a base power source (e.g., a ground or GND). A sustain pulse may be alternately supplied to the scan electrodes and the sustain electrodes during periods that are identical to or shorter than the second period right after the first period. Wall charges may be uniformly distributed over the discharge cells by supplying a ramp pulse to the scan electrodes during the reset period, a scan pulse may be sequentially supplied to the scan electrodes, and a data pulse may be supplied to the address electrodes during the address period, the data pulse being synchronized with the scan pulse.

Another exemplary embodiment of the present invention provides a driving method for a plasma display panel (PDP) comprising a plurality of discharge cells, wherein the PDP is configured to display an image frame comprising a plurality of subfields, each subfield comprising a reset period, an address period, and a sustain period, the driving method including uniformly distributing wall charges over the discharge cells during the reset period; selecting discharge cells from the plurality of discharge cells to be turned on during the address period; and causing a sustain discharge in the discharge cells during the sustain period, the discharge cells being selected during the address period, wherein causing the first sustain discharge during the sustain period includes causing a weak discharge between the scan electrodes and the address electrodes; and causing a strong discharge between the scan electrodes and sustain electrodes after the weak discharge.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram showing a plasma display panel according to one exemplary embodiment of the present invention.

FIG. 2 is a waveform diagram showing one exemplary embodiment of a drive waveform supplied during a subfield period.

FIGS. 3A and 3B are cross-sectional schematic diagrams showing wall charges formed by a first sustain discharge.

FIG. 4 is a waveform diagram showing another exemplary embodiment of a drive waveform supplied during a subfield period.

### DETAILED DESCRIPTION OF EXEMPLARY EMBODIMENTS

Hereinafter, certain exemplary embodiments according to the present invention will be described with reference to the accompanying drawings. Here, when a first element is described as being coupled to a second element, the first element may be directly coupled to the second element or may be indirectly coupled to the second element via a third element. Further, some of the elements that are not essential to the complete understanding of the invention are omitted for clarity. Also, while wall charges are being described as formed on scan, sustain, and address electrodes, those skilled in the art would realize that they are formed on a wall (e.g., a dielectric layer) covering the electrodes. Like reference numerals refer to like elements throughout.

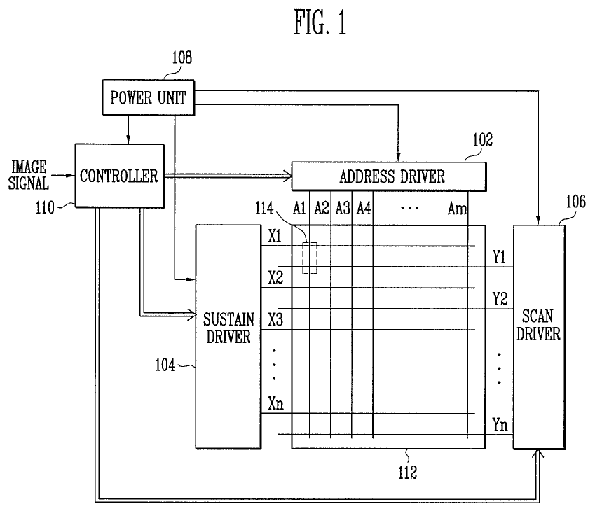

FIG. 1 is a schematic block diagram showing a plasma display panel according to one exemplary embodiment of the present invention.

Referring to FIG. 1, the PDP according to one exemplary embodiment of the present invention includes a display panel 112, an address driver 102, a sustain driver 104, a scan driver 106, a power unit 108, and a controller 110.

The display panel 112 includes scan electrodes (Y1 to Yn) and sustain electrodes (X1 to Xn) that are formed in parallel to each other, and address electrodes (A1 to Am) that cross the scan electrodes (Y1 to Yn). Here, discharge cells 114 are formed at crossing points of the scan electrodes (Y1 to Yn), the sustain electrodes (X1 to Xn) and the address electrodes (A1 to Am). This exemplary embodiment of the present invention is related to a particular structure of electrodes (Y, X and A) constituting the discharge cell 114, but the present invention is not limited thereto.

The controller 110 receives an image signal from the outside, and generates control signals for controlling the address driver 102, the sustain driver 104 and the scan driver 106. Here, the controller 110 generates control signals to drive one frame including a plurality of subfields, each of which has a reset period, an address period and a sustain period.

The address driver 102 selects discharge cells 114 to be turned on by supplying a data pulse to the address electrodes (A1 to Am) during the address periods of the subfields according to the control signals supplied from the controller 110.

The sustain driver 104 supplies a sustain pulse to the sustain electrodes (X1 to Xn) during the sustain periods of the subfields according to the control signals supplied from the controller 110.

The scan driver 106 controls a drive waveform supplied to the scan electrodes (Y1 to Yn) according to the control signals supplied from the controller 110. That is to say, the scan driver 106 supplies a ramp pulse to the scan electrodes (Y1 to Yn) during the reset periods of the respective subfields, and sequentially supplies a scan pulse to the scan electrodes (Y1 to Yn) during the address period. Also, the scan driver 106 and the sustain driver 104 supply a sustain pulse alternately to the sustain electrodes (X1 to Xn) and the scan electrodes (Y1 to Yn) during the sustain periods of the respective subfields.

The power unit 108 supplies a power source (i.e., power) to the controller 110 and the drivers 102, 104 and 106, the power source driving the plasma display device.

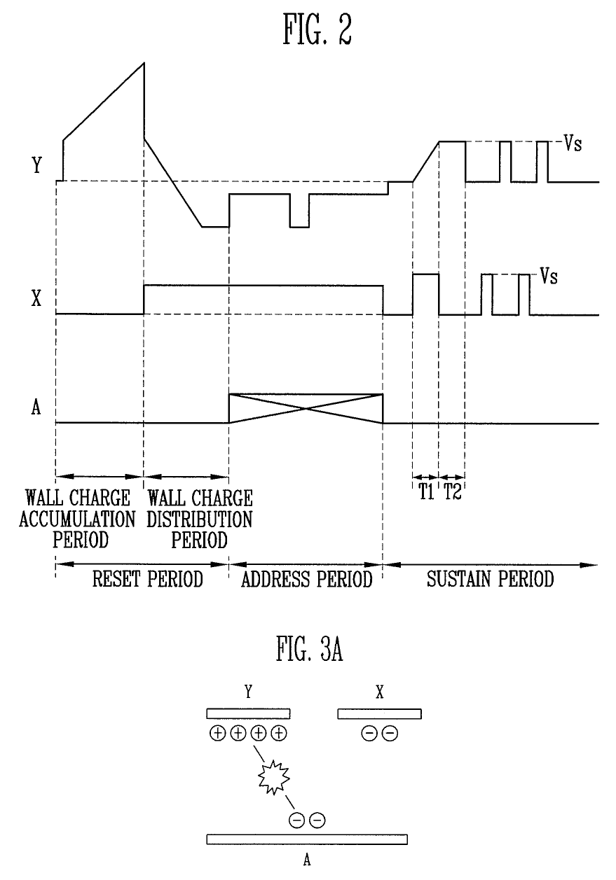

FIG. 2 is a waveform diagram showing a first subfield out of a plurality of subfields in one frame of the plasma display panel according to one exemplary embodiment of the present invention. FIG. 2 illustrates a particular drive waveform supplied during a reset period and an address period, however one skilled in the art will understand that the present invention is not limited thereto.

Referring to FIG. 2, the PDP according to one exemplary embodiment of the present invention is driven with the subfields of the PDP including a reset period, an address period, and a sustain period.

A rising ramp pulse that ascends with a gradient that may be predetermined is supplied to the scan electrodes (Y) during a wall charge accumulation period of the reset period. When the rising ramp pulse is supplied to the scan electrodes (Y), weak discharges are generated in the discharge cells 114, and wall charges are accumulated in the discharge cells 114 by the generated weak discharges.

A falling ramp pulse that falls down with a gradient (e.g., a predetermined gradient) is supplied to the scan electrodes (Y) during the wall charge distribution period of the reset period, and a voltage (which may be predetermined) is applied to the sustain electrodes (X). When the falling ramp pulse is supplied to the scan electrodes (Y), weak discharges are generated in the discharge cells 114, and some wall charges formed during the wall charge accumulation period are reduced by the weak discharges. That is to say, the generation of excessively strong discharges is prevented during the address period by reducing the amount of the wall charges, which are accumulated in the discharge cells 114 during the wall charge accumulation period, during the wall charge distribution period.

During the address period, a scan signal is sequentially supplied to the scan electrodes (Y), and a data signal (i.e., address signal) synchronized with the scan signal is supplied to the address electrodes (A). Then, an address discharge occurs in the discharge cells 114 to which the data signal is applied, wherein the address discharge is caused by adding the wall voltages, which are formed during the reset period, to voltages of the scan signal and the data signal. Wall charges required for the sustain discharge are generated in the discharge cells 114 in which the address discharge occurs.

During the sustain period, a sustain discharge occurs in the discharge cells 114 selected by the address discharge by alternately supplying a sustain pulse with a sustain voltage (Vs) to the scan electrodes (Y) and the sustain electrodes (X). Here, an image with a luminance (which may be predetermined) is displayed in the display panel 112 to correspond to the number of the generated sustain discharges.

According to various embodiments of the present invention, an initial sustain discharge is generated so that a strong discharge between the scan electrodes (Y) and the sustain electrodes (X) is facilitated, but a discharge between the scan electrodes (Y) and the address electrodes (A) is suppressed.

For this purpose, a ramp pulse as an initial sustain pulse is supplied to the scan electrodes (Y) during the sustain period in the present invention. More particularly, a first sustain pulse supplied to the scan electrodes (Y) is a ramp pulse that ascends to a sustain voltage (Vs) with a certain gradient. A drive signal at the sustain voltage is supplied to the sustain electrode (X) during a period when the first sustain pulse of the scan electrodes (Y) ascends to the sustain voltage (Vs) with a certain gradient.

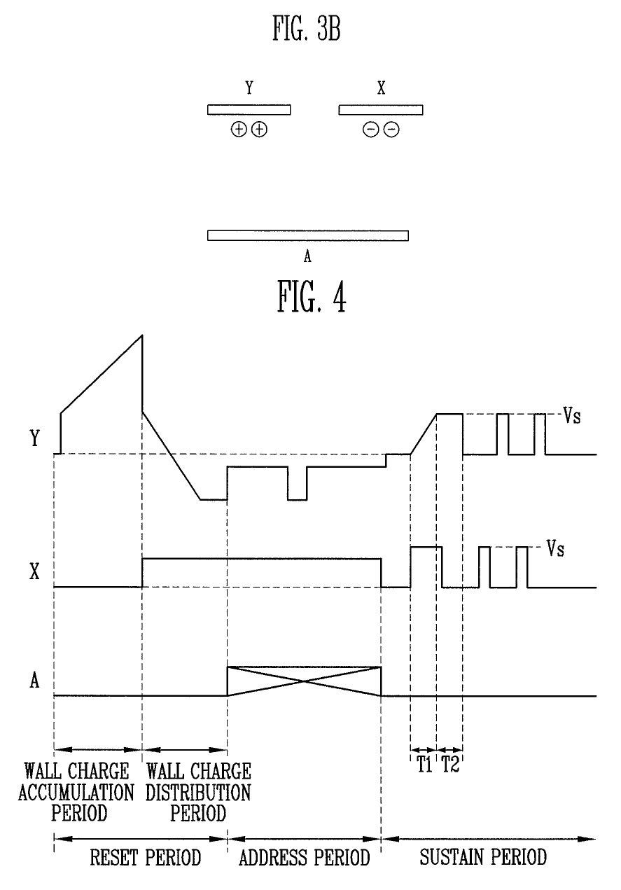

In this case, the voltage of the ramp pulse with a gradient, which is supplied to the scan electrodes (Y), and the voltage of positive wall charges that are formed on the scan electrodes (Y) by the address discharge as shown in FIG. 3A, are summed during the first period (T1). Then, a weak discharge between the scan electrodes (Y) and the address electrodes (A) is generated to remove some of the wall charges formed on the scan electrodes (Y) and the address electrodes (A), as shown in FIG. 3B.

Meanwhile, a drive signal having a sustain voltage is supplied to the sustain electrodes (X) during the first period (T1). Therefore, the discharge does not occur between the scan electrodes (Y) and the sustain electrodes (X). As a result, the sustain electrodes (X) retain the wall charges formed by the address discharge.

The ramp pulse of the scan electrodes (Y) ascending with a certain gradient maintains a sustain voltage (Vs) during a second period (T2). Here, the second period (T2) is identical to or wider than the width of a sustain pulse to be supplied later. A voltage of a base power source (e.g., GND) is supplied to the sustain electrodes (X) during the second period (T2).

Then, a strong sustain discharge occurs between the scan electrodes (Y) and the sustain electrodes (X) during the second period (T2). That is to say, the discharge does not occur between the scan electrodes (Y) and the address electrodes (A) during the second period (T2), but a strong sustain discharge occurs between the scan electrodes (Y) and the sustain electrodes (X). Subsequently, the sustain discharge stably occurs by the sustain pulses that are alternately supplied to the sustain electrodes (X) and the scan electrodes (Y).

That is to say, according to an exemplary embodiment of the present invention, the wall charges formed on the address electrodes (A) are removed by supplying a ramp pulse as the first sustain pulse supplied to the scan electrodes (Y) and supplying a drive signal to the sustain electrodes (X) during a period when a ramp pulse is ascending. Then, the sustain discharge may be stabilized by causing a strong sustain discharge between the scan electrodes (Y) and the sustain electrodes (X).

FIG. 4 is a waveform diagram showing a first subfield out of a plurality of subfields in one frame of the plasma display panel 112 according to another exemplary embodiment of the present invention. In FIG. 4, detailed descriptions of the same waveforms as in FIG. 2 are omitted for clarity.

Referring to FIG. 4, a sustain pulse having a sustain voltage (Vs) is alternately supplied to the scan electrodes (Y) and the sustain electrodes (X) during the sustain period of the plasma display panel according to another exemplary embodiment of the present invention. Therefore, the sustain discharge occurs in the discharge cells 114 selected by the address discharge.

Here, the initial sustain discharge occurs so that the discharge between the scan electrodes (Y) and the address electrodes (A) is suppressed while the strong discharge occurs between the scan electrodes (Y) and the sustain electrodes (X).

For this purpose, a ramp pulse that ascends to the sustain voltage (Vs) as the first sustain pulse is supplied to the scan electrodes (Y) during the sustain period according to another exemplary embodiment of the present invention. A drive signal having a sustain voltage is supplied to the sustain electrodes (X) during a period when a ramp pulse is supplied to the scan electrodes (Y).

After the rising ramp pulse is supplied to the scan electrodes (Y), a voltage of the scan electrodes (Y) maintains a sustain voltage (Vs) during the second period (T2). And, a drive signal having a sustain voltage (Vs) is supplied to the sustain electrodes (X) during some portion of the second period (T2), and a voltage of the base power source (e.g., GND) is supplied to the sustain electrodes (X) during the remaining portion of the second period (T2).

More particularly, in this embodiment, the signal supplied to the sustain electrodes (X) maintains the sustain voltage (Vs) during some portion of the second period (T2). During this time, the discharge does not occur since the same voltage (i.e., a sustain voltage) is supplied to the scan electrodes (Y) and the sustain electrodes (X). A base power source (e.g., GND) is supplied to the sustain electrodes (X) during the remaining portion of the second period (T2). When the base power source (e.g., GND) is supplied to the sustain electrodes (X), the strong sustain discharge occurs due to the difference in the voltage between the sustain electrodes (X) and the scan electrodes (Y). That is to say, the discharge generally does not occur between the scan electrodes (Y) and the address electrodes (A) during the second period (T2), and the strong sustain discharge does occur between the scan electrodes (Y) and the sustain electrodes (X). Then, the sustain discharge occurs stably by means of the sustain pulse that is alternately supplied to the sustain electrodes (X) and the scan electrodes (Y).

In the case of the above-mentioned drive waveform according to another exemplary embodiment of the present invention, the drive signal having a sustain voltage (Vs) is supplied to the sustain electrodes (X) during the first period (T1) when a rising ramp pulse is supplied to the scan electrodes (Y), and a part of the second period (T2). Here, the sustain discharge stably occurs when the period during which the drive signal is supplied to the sustain electrodes (X) overlaps with the first period (T1) and be partially overlaps with the second period (T2).

In the embodiment illustrated in FIG. 4, the period where a drive signal is supplied to the sustain electrodes (X) during the second period (T2) is shorter than the period where a drive signal is not supplied to the sustain electrodes (X). In this embodiment, the first sustain discharge may occur for a sufficient time only when a portion of the second period (T2), during which a drive signal is supplied to the sustain electrodes (X), is shorter than the period during which the drive signal is not supplied to the sustain electrodes (X).

As described above, the driving method of a plasma display panel according to the present invention may be useful to prevent the opposed discharge (i.e., discharge between the opposing surfaces) from occurring between the scan electrodes (Y) and the address electrodes (A) by supplying a ramp pulse to the scan electrodes (Y) and supplying a drive signal to the sustain electrodes (X) just prior to the occurrence of the first sustain discharge. Therefore, the strong discharge may be caused to display an image with desired luminance in the occurrence of the sustain discharge in exemplary embodiments of the present invention.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A driving method for a plasma display panel comprising scan electrodes, sustain electrodes, and address electrodes, the scan electrodes and the sustain electrodes crossing the address electrodes at discharge cells, wherein the plasma display panel is configured to display an image during a frame comprising a plurality of subfields, each subfield comprising a reset period, an address period, and a sustain period, the driving method comprising:
applying a signal gradually rising to a first voltage to the scan electrodes during a first period of the sustain period; and
applying a pulse having a second voltage to the sustain electrodes during the first period.

2. The driving method for a plasma display panel according to claim 1, further comprising maintaining the first voltage on the scan electrodes during a second period right after the first period.

3. The driving method for a plasma display panel according to claim 2, further comprising applying a third voltage, which is lower than the second voltage, to the sustain electrodes during the second period.

4. The driving method for a plasma display panel according to claim 3, wherein the third voltage is a voltage of a base power source.

5. The driving method for a plasma display panel according to claim 2, further comprising maintaining the second voltage on the sustain electrodes during an initial portion of the second period, and applying a third voltage, which is lower than the second voltage, to the sustain electrodes during a second portion of the second period following the initial portion of the second period.

6. The driving method for a plasma display panel according to claim 2, further comprising alternately supplying a sustain pulse to the scan electrodes and the sustain electrodes during periods that are identical to or shorter than the second period right after the first period.

7. The driving method for a plasma display panel according to claim 1, wherein a first sustain pulse is supplied to the scan electrodes during a second period right after the first period.

8. The driving method for a plasma display panel according to claim 1, wherein the first voltage and the second voltage are set to a sustain voltage.

9. The driving method for a plasma display panel according to claim 1, further comprising:
uniformly distributing wall charges over the discharge cells by supplying a ramp pulse to the scan electrodes during the reset period; and
sequentially supplying a scan pulse to the scan electrodes and supplying a data pulse to the address electrodes during the address period, the data pulse being synchronized with the scan pulse.

10. A driving method for a plasma display panel (PDP) comprising a plurality of discharge cells, wherein the PDP is configured to display an image during a frame comprising a plurality of subfields, each subfield comprising a reset period, an address period, and a sustain period, the driving method comprising:
uniformly distributing wall charges over the discharge cells during the reset period;
selecting discharge cells from the plurality of discharge cells to be turned on during the address period; and
causing a sustain discharge in the discharge cells during the sustain period, the discharge cells being selected during the address period,
wherein causing the first sustain discharge during the sustain period comprises:
causing a weak discharge between the scan electrodes and the address electrodes; and
causing a strong discharge between the scan electrodes and sustain electrodes after the weak discharge between the scan electrodes and the address electrodes.

11. A plasma display device configured to be driven during a reset period, an address period, and a sustain period, the plasma display device comprising:
a plasma display panel comprising a plurality of discharge cells defined by a plurality of scan electrodes, a plurality of sustain electrodes parallel to the scan electrodes, and a plurality of address electrodes crossing the scan and sustain electrodes;
an address driver configured to supply data signals to the address electrodes to select light emitting cells from among the discharge cells during the address period;
a scan driver configured to supply a reset waveform to the scan electrodes during the reset period, scan signals in synchronization with the address signals during the address period, and a ramping up signal and first sustain pulses to the scan electrodes during the sustain period; and
a sustain driver configured to provide second sustain pulses to the sustain electrodes during the sustain period, one of the second sustain pulses to be supplied while the ramping up signal is being supplied to the scan electrodes.

12. The plasma display device according to claim 11, wherein the ramping up signal gradually rises to a first voltage during a first period, and the scan driver is further configured to maintain the first voltage on the scan electrodes during a second period right after the first period.

13. The plasma display device according to claim 12, wherein the sustain driver is further configured to apply a voltage that is lower than the one of the second sustain pulses, during the second period right after the first period.

14. The plasma display device according to claim 13, wherein the first voltage and a voltage of the one of the second sustain pulses are set to a sustain voltage.

15. The plasma display device according to claim 13, wherein the voltage that is lower than the one of the second sustain pulses is a voltage of a base power source.

16. The plasma display device according to claim 12, wherein the scan driver and sustain driver are further configured to alternately supply first and second sustain pulses to the scan electrodes and the sustain electrodes during periods that are identical to or shorter than the second period right after the first period.
